(19) United States
(12) Patent Application Publication
(10) Pub. No.: US 2011/0225088 A1
(43) Pub. Date: Sep. 15, 2011

(54) RECEIVER-BASED FUNDS TRANSFER

(75) Inventor: Michael J. Michelsen, Arvada, CO (US)

(73) Assignee: The Western Union Company, Englewood, CO (US)

(21) Appl. No.: 12/723,118

(22) Filed: Mar. 12, 2010

(51) Int. Cl. G06Q 40/00

(52) U.S. Cl. 705/44

(57) ABSTRACT

Methods, systems, and devices are described for a receiver-initiated funds transfer. A prospective receiver of a funds transfer may identify a funds transfer amount and provide a sender identifier, to thereby initiate and request the funds transfer. Authorization for the funds transfer may be received from a sender corresponding to the sender identifier. Funds associated with the funds transfer and sourced from the sender may be received. The funds transfer may be made in response the receiver-initiated request.

### BACKGROUND

The present invention relates to funds transfers in general and, in particular, to receiver-initiated funds transfers. Funds transfer services are used extensively to transfer money between a sender of funds and a receiver of funds. The use of such services typically involves the sender going to an agent location, identifying the transfer amount and funding the transfer, and identifying the funds receiver and the location for pickup.

Thus, much of the inconvenience involved with the funds transfer is borne by the sender of funds. However, much of the information provided by the sender initiating the transfer is available to the receiver of funds. In fact, the preferred location and timing for the pickup of a funds transfer may be better known by the receiver. Moreover, the benefit of the funds transfer is directed at the receiver. Thus, there may be a need in the art for novel receiver-initiated funds transfer systems.

### SUMMARY

Methods and systems are described for receiver-initiated funds transfers. A prospective receiver of a funds transfer may identify a funds transfer amount and provide a sender identifier, to thereby initiate and request the funds transfer. Authorization for the funds transfer may be received from a sender corresponding to the sender identifier. Funds associated with the funds transfer and sourced from the sender may be received. The funds transfer may be made in response to the receiver-initiated request.

In some embodiments, a host computer system may be configured to receive, from a prospective receiver of a funds transfer, an identification of a requested funds transfer amount and a sender identifier to initiate the funds transfer. The host computer system may receive, from a sender corresponding to the sender identifier, authorization for the funds transfer. The host computer system may receive a first amount of funds associated with the funds transfer and sourced from the sender, and transfer a second amount of funds associated with the funds transfer, the second amount lower than the first amount.

The authorization may be received before, or after, the identification of the requested funds transfer amount and the sender identifier is received from the prospective receiver. The authorization may be received when the sender establishes or updates an account with a funds transfer service provider. The authorization may be a selection by a sender of a receiver who can originate a funds transfer and one or more rules for the funds transfer. The authorization may be received via mail, at an agent location, or online through the host computer system.

The transfer may be made upon receiving the identification of the requested funds transfer amount and the sender identifier, and before the authorization is received. Alternatively, the transfer may be made after the authorization is received and upon confirmation of receipt of payment.

The sender may establish an account with a funds transfer service provider before the identification of the requested funds transfer amount and the sender identifier is received. The receiver may establish an account with a funds transfer service provider before the identification of the requested funds transfer amount and the sender identifier is received. These accounts may be established through mail, at an agent location, or online through the host computer system.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram illustrating a system for receiver-initiated funds transfers according to various embodiments of the invention.

FIG. 2 is a block diagram illustrating a host computer system for receiver-initiated funds transfers according to various embodiments of the invention.

FIG. 3 is a block diagram illustrating a system for receiver-initiated funds transfers using agent locations according to various embodiments of the invention.

FIG. 4 is a block diagram illustrating a system for receiver-initiated funds transfers using financial institution accounts according to various embodiments of the invention.

FIG. 5 is a flow chart illustrating a method for a receiver-initiated funds transfer according to various embodiments of the invention.

FIG. 6 is a flow chart illustrating a method for a receiver-initiated funds transfer to an agent location according to various embodiments of the invention.

FIG. 7 is a flow chart illustrating a method for a receiver-initiated funds transfer to a receiver's financial institution according to various embodiments of the invention.

FIG. 8 is a schematic diagram that illustrates a representative device structure that may be used in various embodiments of the present invention.

### DETAILED DESCRIPTION OF THE INVENTION

Methods and systems are described for receiver-initiated funds transfers. A prospective receiver may initiate a funds transfer by identifying a funds transfer amount and a sender identifier. Authorization for the funds transfer may be received from a sender corresponding to the sender identifier. Funds associated with the funds transfer and sourced from the sender may be received. The funds transfer may be made in response to the receiver-initiated request.

This description provides examples, and is not intended to limit the scope, applicability, or configuration of the invention. Rather, the ensuing description of the embodiments will provide those skilled in the art with an enabling description for implementing embodiments of the invention. Various changes may be made in the function and arrangement of elements without departing from the spirit and scope of the invention.

Thus, various embodiments may omit, substitute, or add, various procedures or components as appropriate. For instance, it should be appreciated that in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner.

It should also be appreciated that the following systems, methods, and software may individually or collectively be components of a larger system, wherein other procedures may take precedence over or otherwise modify their application. Also, a number of steps may be required before, after, or concurrently with the following embodiments.

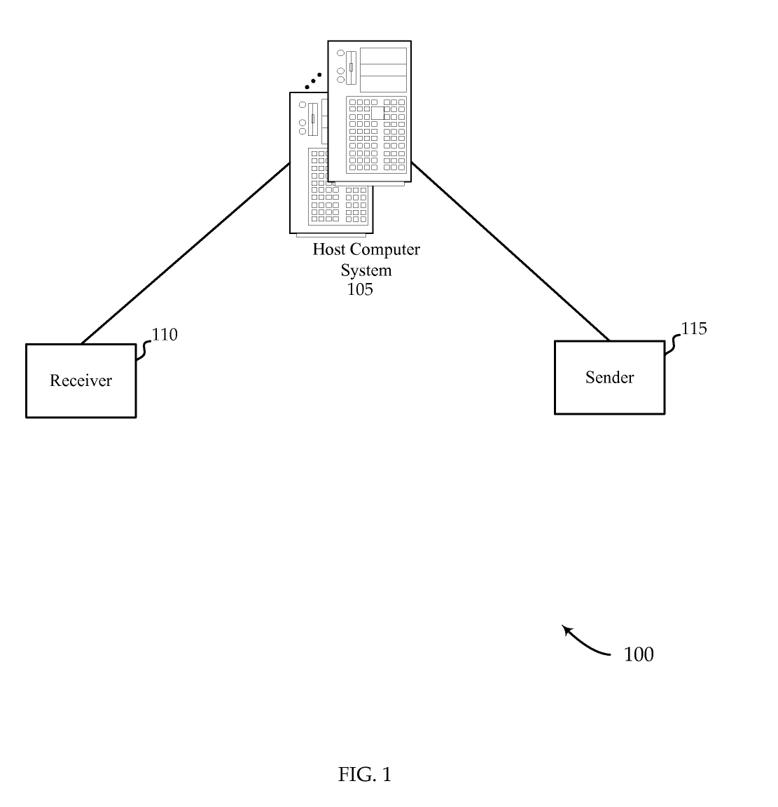

Systems, devices, methods, and software are described for receiver-initiated funds transfers. In one set of embodiments, shown in FIG. 1, the system 100 includes a host computer system 105. The host computer system 105 is in communication, directly or indirectly, with a receiver 110 of funds and a sender 115 of funds. The receiver 110 and sender 115 may each communicate with the host computer system 105 via respective computing devices (e.g., a personal computer, a mobile device, or a device at an agent location operated by an agent or used by the receiver 110). The components of the system 100 may be directly connected, or may be connected via a network.

The host computer system 105 may include, for example, one or more server computers, workstations, web servers, or other suitable computing devices. The host computer system 105 may be fully located within a single facility or distributed geographically, in which case a network may be used to integrate different components.

The host computer system 105 may receive, from a prospective receiver 110 of a funds transfer, various information to initiate a funds transfer. The receiver 110 may identify a sender 115 of the funds. By way of example, the receiver 110 may identify the sender 115 by name, account number, email address, or another alphanumeric sender identifier unique to or otherwise identifying the sender 115. The receiver 110 may also identify a requested funds transfer amount (which may be the same, or different, from the amount actually transferred, as there may be fees involved). The sender identifier and amount may be sent, and/or received, at different times. The receiver 110 may make these identifications via mail, at an agent location, online through the host computer system 105, or over the phone to an interactive voice response (IVR) system or a live operator. An IVR system may be any form of an automated, interactive telephone system. The receiver may initiate the funds transfer before the prospective sender has set up an account.

The host computer system 105 may receive authorization for the funds transfer from a sender 115 corresponding to the sender identifier. The sender 115 may give this authorization in a number of different ways. For example, the authorization may be via mail, at an agent location, or online through the host computer system 105. The authorization may be received at the host computer system 105 before, or after, the receipt of the requested funds transfer amount and/or the sender identifier. Thus, the sender 115 may receive a phone call, text message, email, or other notification indicating that a prospective receiver 110 has requested a funds transfer, and specifically authorize the funds transfer requested by the receiver 110 (e.g., by responding to an email and providing a credit or debit card payment, or going to an agent location and making payment in response to the request). However, the authorization may be received when the sender 115 establishes or updates an account with a funds transfer service provider, and thus there may be a pre-authorized transfer. Therefore, while in some embodiments the sender may have a pre-established account to authorize the transfer, in other embodiments no such account is necessary. It is worth noting that a sender account may be established before or after the receiver 110 identifies the requested amount for the funds transfer and identifies the sender.

Thus, the authorization may be a selection by a sender 115 of a receiver 110 who can originate a funds transfer and one or more rules for the funds transfer. These rules may be established when the sender 115 account is set up, or thereafter. The sender 115 may make all disclosures during account set up, and all legally necessary communications may be made or otherwise distributed at that time. The sender 115 account may be set up via mail, at an agent location, or online through the host computer system 105. The sender 115 may select a receiver 110 who can originate funds transfers for which they will be billed, and other rules. The rules may specify which receivers may access funds, and specify (perhaps for each receiver) how often the transfers may be initiated, maximum amounts per transfer, maximum amounts over time periods (e.g., maximum amount per week, month, year), where and when the transfer may be picked up (e.g., a specific agent location), or where the funds may be transferred to (e.g., a receiver 110 account at a financial institution). The sender 115 may determine a billing arrangement when setting up the account or when otherwise giving the authorization (e.g., payment may be billed or withdrawn from a bank account, or a debit or credit card, or billed by receiving notification (mail, telephone call) and going to an agent location to pay). In one embodiment, the sender account may be pre-funded and maintained (e.g., by the funds transfer service provider), and the transfer amount can be drawn from this pre-funded account.

The host computer system 105 may receive a first amount of funds associated with the funds transfer and sourced from the sender, and transfer a second amount of funds associated with the funds transfer, the second amount lower than the first amount. The transfer may be made before, or after, the authorization is received and/or confirmation of receipt of payment. For example, in one embodiment, the transfer may occur only once the authorization has been received at the host computer system 105, and upon confirmation of receipt of payment. For example, the funds may be transferred upon receiving the funds or receiving a real time confirmation of receipt of payment from sender's 115 bank account, debit card, or credit card. The sender 115 may also have a balance maintained with the funds transfer service provider from which the funds may be debited.

Alternatively, in one embodiment, the transfer may occur after the authorization has been received at the host computer system 105, and before confirmation of receipt of payment (e.g., with a creditworthy sender 115). In another embodiment, the transfer may occur upon demand before the authorization has been received at the host computer system 105, and before confirmation of receipt of payment (e.g., with a creditworthy receiver 110). Once the transfer is made, the receiver may be notified via email, text message, or an phone message (automated or otherwise).

It is also worth noting that the receiver 110 may establish an account with a funds transfer service provider before the identification of the requested funds transfer amount and the sender identifier is received. The sender 115 may be identified upon account setup. The account may be established through mail, at an agent location, or online through the host computer system. While in some embodiments the receiver may have a pre-established account to initiate the transfer, in other embodiments no such account is necessary.

The components of the system 100 may be directly connected, or may be connected via a network, which may be any combination of the following: the Internet, an IP network, an intranet, a wide-area network (“WAN”), a local-area network (“LAN”), a virtual private network, the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically. If no specific means of connection is noted, it may be assumed that the link, communication, or other connection between devices may be via a network.

The host computer system 105 may be owned, controlled, and/or operated, in whole or in part, by a funds transfer service provider. The host computer system 105 may also be operating as an agent for a funds transfer service provider.

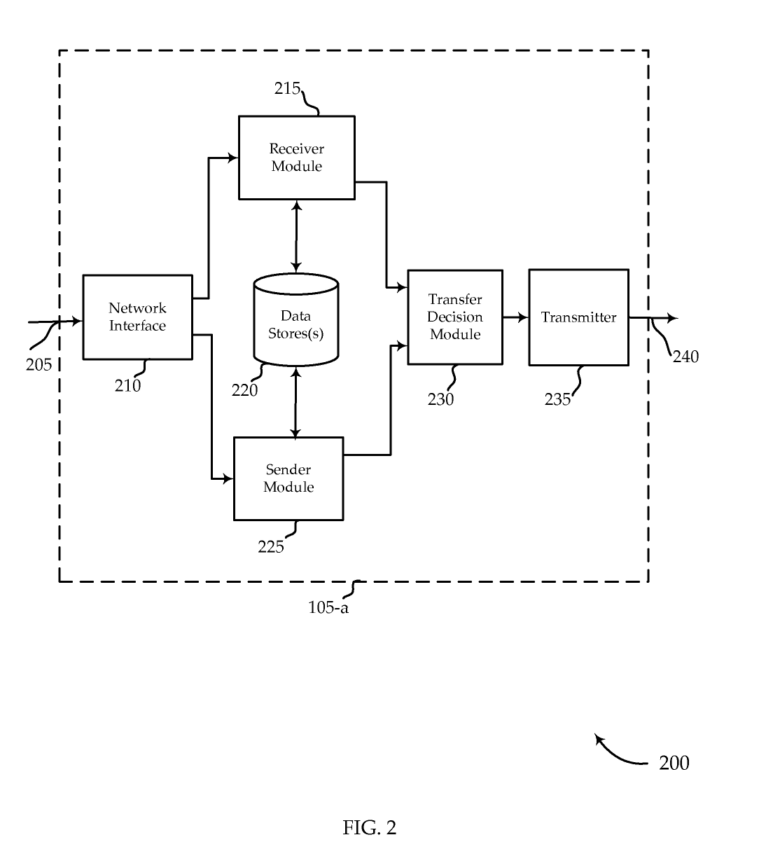

FIG. 2 is a block diagram 200 illustrating a host computer system 105-a for receiver-initiated funds transfers according to various embodiments of the invention. The host computer system 105-a may, but need not be, the host computer system 105 of FIG. 1. The host computer system 105-a may include a network interface 210, receiver module 215, data store(s) 220, sender module 225, transfer decision module 230, and transmitter 235, which may each be in communication with each other, directly or indirectly.

The modules of the host computer system 105-a may, collectively or individually, be one or more server computers, workstations, web servers, or other suitable computing devices. The host computer system 105 may be fully located within a single facility or distributed geographically, in which case a network may be used to integrate different components. The functionality of each device may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions also be implemented, in whole or in part, with instructions embodied in a memory, formatted to be executed by one or more general or application-specific processors.

The host computer system 105-a may receive data 205 via the network interface 210, directly or indirectly, from a receiver of funds and a sender of funds (e.g., receiver 110 or sender 115 of FIG. 1). The receiver module 215 may receive various information to initiate a funds transfer from the funds receiver, and store the information in data stores(s) 220. The receiver module 215 may receive identification of the prospective sender by name, account number, email address, or another alphanumeric sender identifier unique to or otherwise identifying the sender. The receiver module 215 may also receive a requested funds transfer amount (which may be the same, or different, from the amount actually transferred, as there may be fees involved).

When the sender identifier and amount is received, the transfer decision module 230 may determine whether further authorization is needed. If so, the transfer decision module 230 may cause the transmitter 235 to transmit data 240 requesting authorization to the prospective sender of funds.

The sender module 225 may receive data 205 to authorize the funds transfer from the sender, and store this data in data store(s) 220. The sender may give this authorization in a number of different ways, as described in more detail elsewhere in this description. The sender module 225 may receive authorization before, or after, the requested funds transfer amount or the sender identifier is received. Thus, the sender module 225 may receive authorization after and in response to a funds transfer request by the prospective receiver. However, the authorization may be received at the sender module 225 before a request is made, when the sender establishes or updates an account with a funds transfer service provider. The sender module 225 may, therefore, receive information from a sender establishing an account. This account may be established before or after the receiver identifies the requested amount for the funds transfer and identifies the sender.

The sender module 225 may receive a selection by a sender of a receiver who can originate a funds transfer, and one or more rules for the funds transfer. These rules may be established when the sender account is set up, or thereafter. The rules may specify how often the transfers may be initiated, maximum amounts per transfer, maximum amounts over time periods (e.g., maximum amount per week, month, year), where and when the transfer may be picked up (e.g., a specific agent location), or where the funds may be transferred to (e.g., a receiver 110 account at a financial institution).

The sender module 225 may receive notification that a first amount of funds associated with the funds transfer and sourced from the sender has been received, or otherwise credited. The transfer decision module 230 may control transfer of a second amount of funds associated with the funds transfer to the receiver. The second amount may be lower than, or the same, as the first amount. The sender module 225 may cause the transfer to occur using the transmitter 235 to transmit data 240 (e.g., sending an electronic message to an agent location, or causing a funds transfer between accounts).

The transfer may be made before, or after, the authorization is received and/or confirmation of receipt of payment. For example, in one embodiment, the transfer may be controlled to occur only once the authorization has been received, and upon confirmation of receipt of payment. Alternatively, in another embodiment, the transfer may occur after the authorization has been received, and before confirmation of receipt of payment. In yet another embodiment, the transfer may occur upon demand before the authorization has been received, and before confirmation of receipt of payment. The amount transferred may be the amount requested, or may be less, as there may be a service fee.

Data store(s) 220 may include one, or more, relational databases or components of relational databases (e.g., tables), object databases, or components of object databases, spreadsheets, text files, internal software lists, or any other type of data structure suitable for storing data. Thus, it should be appreciated that each data store 220 may each be multiple data storages (of the same or different type), or may share a common data storage with other data stores 220. In some embodiments the data store(s) 220 may be distinct from a host computer system 105.

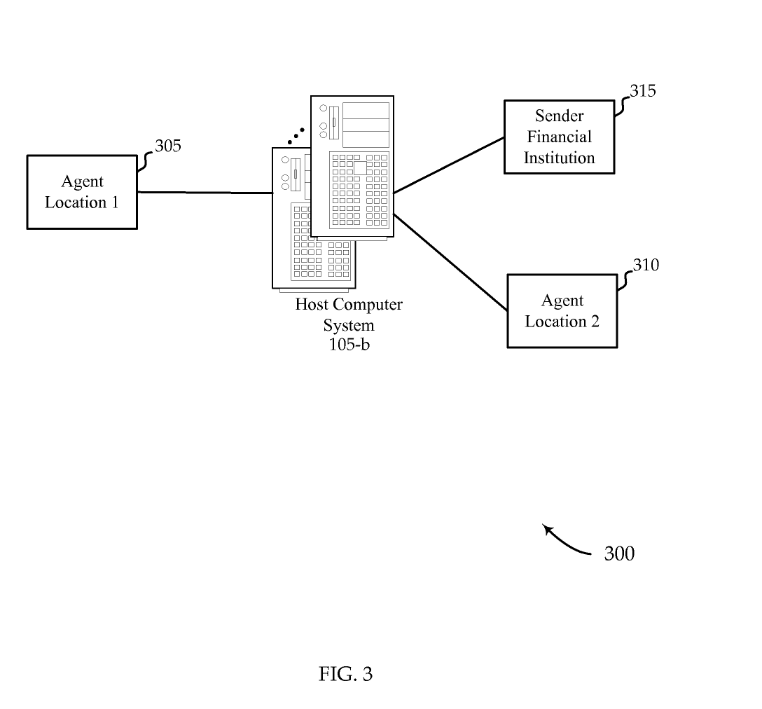

FIG. 3 is a block diagram illustrating a system 300 for receiver-initiated funds transfers using agent locations according to various embodiments of the invention. The system 300 may, but need not, be the system 100 of FIG. 1. The system 300 includes a host computer system 105-b (which may be host computer system 105 of FIG. 1 or 2), agent locations 305, 310, and sender financial institution 315.

To initiate a funds transfer, a prospective receiver of a funds transfer (e.g., receiver 110 of FIG. 1) may visit agent location 1 305 (e.g., in New York, N.Y.). At agent location 1 305, the receiver may use a kiosk to input a requested amount for the funds transfer, and input a sender identifier. In another embodiment, the prospective receiver may verbally provide the information to an agent at the agent location 1 305, who may input the information. The prospective receiver may also write the information on a form for submittal at the agent location 1 305. The information may be transmitted from the agent location 1 305 to the host computer system 105-b. The host computer system 105-b may transmit the request to the prospective sender (e.g., via email or an automated telephone call).

To authorize the requested funds transfer, the sender (e.g., sender 115 of FIG. 1) may visit agent location 2 310 (e.g., in Los Angeles, Calif.). At agent location 2 310, the sender may provide a debit card or credit card number, or a bank account number, to authorize and fund the transfer. The host computer system 105-b may receive authorization from the sender via agent location 2 310. The host computer system 105-b may receive notification that funds associated with the funds transfer and sourced from the sender's financial institution 315 have been provided for the transfer (via the debit card or credit card number, or the bank account number). The host computer system 105-b may control the transfer by transmitting an electronic message to agent location 1 305 to authorize the funds transfer, allowing the receiver to access the money from agent location 1 305. Depending on a number of different factors, the transfer may occur before or after the authorization and actual funding of the transfer.

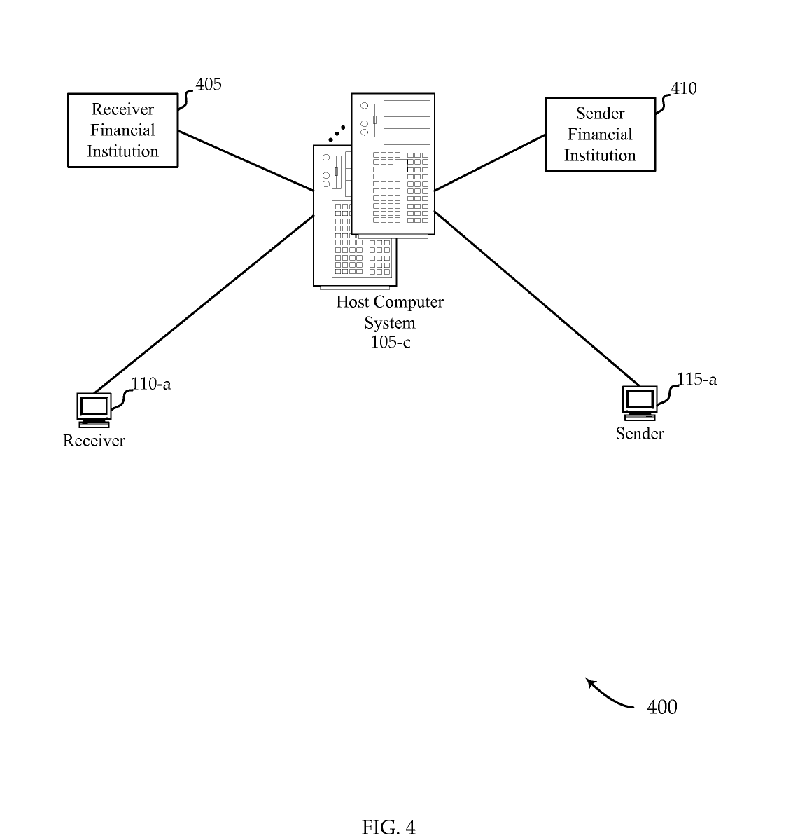

FIG. 4 is a block diagram illustrating a system 400 for receiver-initiated funds transfers using financial institution accounts according to various embodiments of the invention. The system 400 may, but need not, be the system 100 of FIG. 1. The system 400 includes a host computer system 105-c (e.g., host computer system 105 of FIG. 1, 2, or 3), receiver 110-a (e.g., receiver 110 of FIG. 1), receiver financial institution 405, sender 115-a (e.g., sender 115 of FIG. 1), and sender financial institution 410.

To initiate a funds transfer, a prospective receiver 110-a of a funds transfer may use a personal computer or other mobile computing device. Receiver 110-a may input a requested amount for the funds transfer, input a sender identifier, and identify an account to target at receiver financial institution 405. In other embodiments, the prospective receiver may verbally provide the information to an agent at the agent location, input the information at an agent location kiosk, or provide the information over the phone to an interactive voice response (IVR) system or a live operator. An IVR may be any form of automated, interactive telephone system. In some embodiments, the receiver 110-a may have an account set up with the funds transfer service provider, so some of this information may be provided in advance.

To authorize the requested funds transfer, the sender 115-a of a funds transfer may use a personal computer or other mobile computing device. The sender 115-a may receive an email or phone call advising the sender 115-a of the request. The sender 115-a may respond (e.g., via an email response, or over a web interface) by providing a debit card or credit card number, or a bank account number, to authorize and fund the transfer. The host computer system 105-c may receive authorization from the sender 115-a. The host computer system 105-c may receive notification that funds associated with the funds transfer and sourced from the sender's financial institution 410 have been provided for the transfer (via the debit card or credit card number, or the bank account number). The host computer system 105-c may transfer the funds to the target account at the receiver financial institution 405.

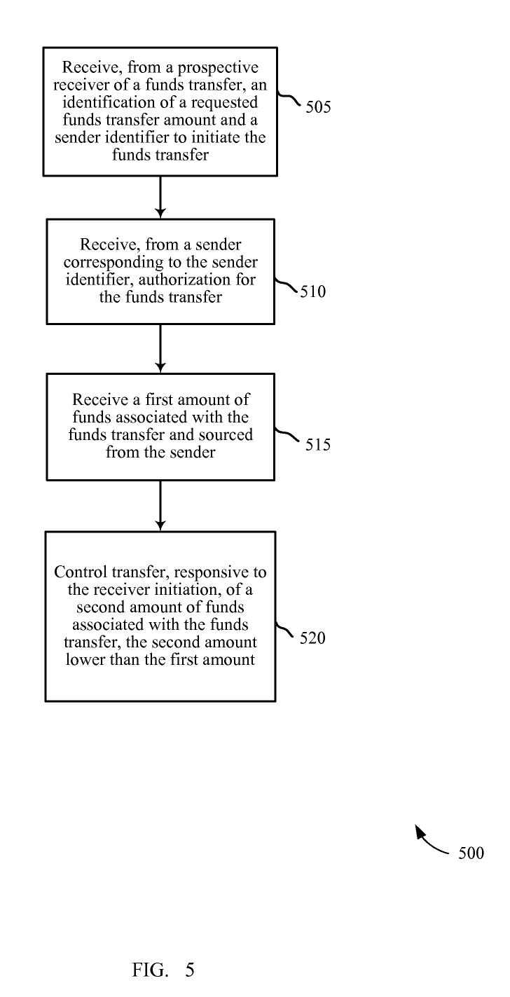

Referring next to FIG. 5, a flow chart is shown illustrating a method 500 for a receiver-initiated funds transfer according to various embodiments of the invention. This method 500 may, for example, be performed in whole or in part by the host computer system 105 of FIG. 1, 2, 3, or 4, in combination with a receiver 110 computing device of FIG. 1 or 4, a sender 115 computing device of FIG. 1 or 4, an agent location 305, 310 computing device of FIG. 3, and/or any combination thereof.

At block 505, an identification of a requested funds transfer amount and a sender identifier are received from a prospective receiver of a funds transfer, to thereby initiate the funds transfer. At block 510, authorization for the funds transfer is received from a sender corresponding to the sender identifier. At block 515, a first amount of funds associated with the funds transfer and sourced from the sender is received. At block 520, responsive to the receiver initiation, the transfer is made of a second amount of funds associated with the funds transfer, the second amount lower than the first amount.

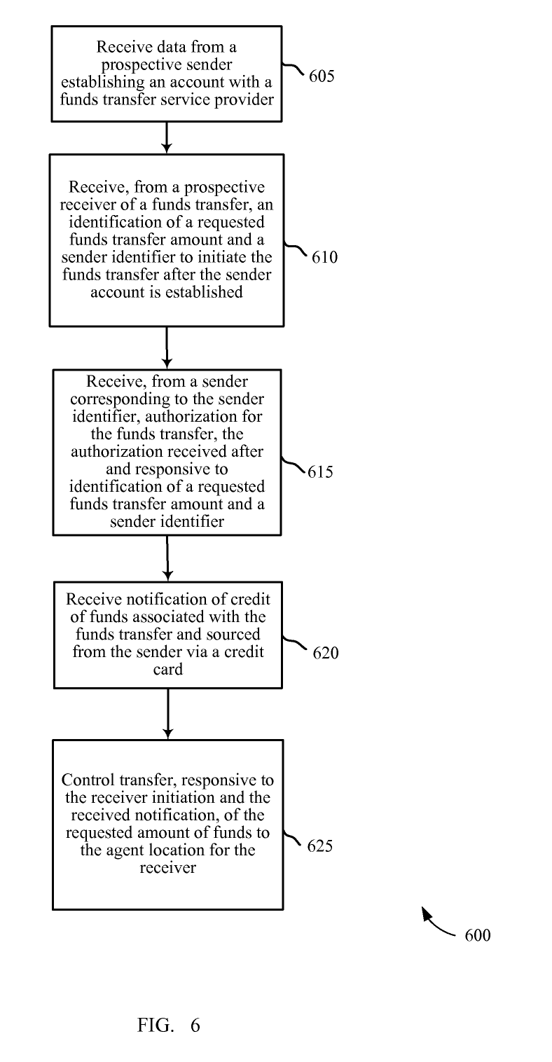

Referring next to FIG. 6, a flow chart is shown illustrating a method 600 for a receiver-initiated funds transfer to an agent location, according to various embodiments of the invention. This method 600 may, for example, be performed in whole or in part by the host computer system 105 of FIG. 1, 2, 3, or 4, in combination with a receiver 110 computing device of FIG. 1 or 4, a sender 115 computing device of FIG. 1 or 4, an agent location 305, 310 computing device of FIG. 3, and/or any combination thereof.

At block 605, data is received from a prospective sender establishing an account with a funds transfer service provider. At block 610, after the sender account is established, an identification of a requested funds transfer amount and a sender identifier are received from a prospective receiver of a funds transfer to initiate the funds transfer. At block 615, authorization for the funds transfer is received from a sender corresponding to the sender identifier, the authorization received after and responsive to the identification of the requested funds transfer amount and the sender identifier. At block 620, notification is received of credit of funds associated with the funds transfer and sourced from the sender via a credit card. At block 625, responsive to the receiver initiation and the received notification, transfer of the requested amount of funds to the agent location for the receiver is made.

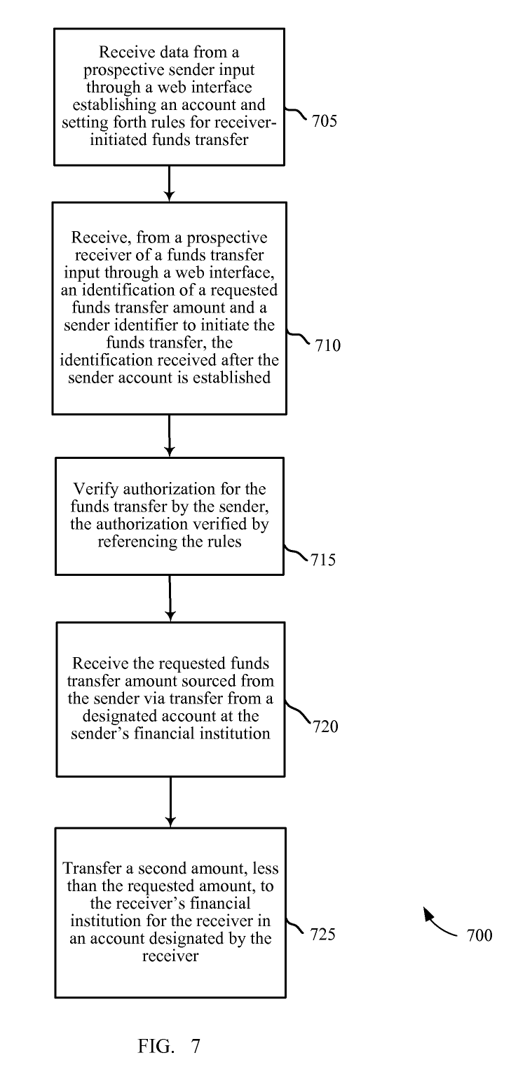

Referring next to FIG. 7, a flow chart is shown illustrating a method 700 for a receiver-initiated funds transfer to a receiver's financial institution, according to various embodiments of the invention. This method 700 may, for example, be performed in whole or in part by the host computer system 105 of FIG. 1, 2, 3, or 4, in combination with a receiver 110 computing device of FIG. 1 or 4, a sender 115 computing device of FIG. 1 or 4, an agent location 305, 310 computing device of FIG. 3, and/or any combination thereof.

At block 705, data is received from a prospective sender input through a web interface establishing an account and setting forth rules for receiver-initiated funds transfer. At block 710, an identification of a requested funds transfer amount and a sender identifier to initiate the funds transfer are received from a prospective receiver of a funds transfer input through a web interface, the identification received after the sender account is established. At block 715, authorization for the funds transfer is verified, the authorization verified by referencing the rules. Thus, in one embodiment, there is a pre-authorization provided by a sender. At block 720, the requested funds transfer amount is received, the amount sourced from the sender via transfer from a designated account at the sender's financial institution. At block 725, a second amount, less than the requested amount, is transferred to the receiver's financial institution for the receiver in an account designated by the receiver.

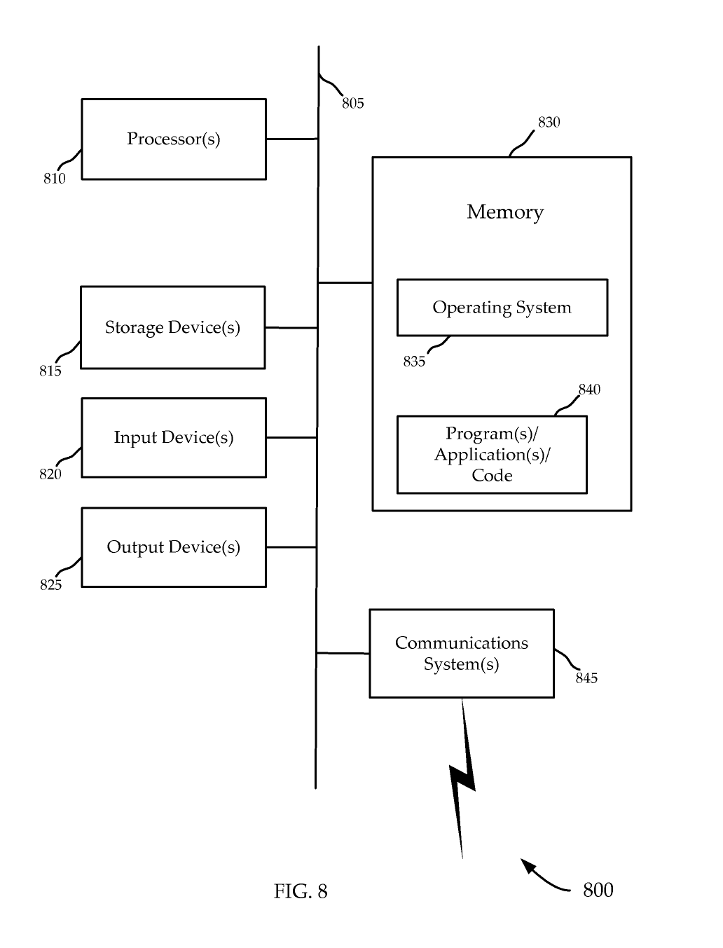

A device structure 800 that may be used for a host computer system 105 of FIG. 1, 2, 3, or 4, a receiver 110 computing device of FIG. 1 or 4, the sender 115 computing device of FIG. 1 or 4, the agent location 305, 310 computing devices of FIG. 3, or for other computing devices described herein, is illustrated with the schematic diagram of FIG. 8. This drawing broadly illustrates how individual system elements of each of the aforementioned devices may be implemented, whether in a separated or more integrated manner. The example structure is shown made up of hardware elements that are electrically coupled via bus 805, including processor(s) 810 (which may further comprise a DSP or special-purpose processor), storage device(s) 815, input device(s) 820, and output device(s) 825. The storage device(s) 815 may be a machine-readable storage media reader connected to any machine-readable storage medium, the combination comprehensively representing remote, local, fixed, or removable storage devices or storage media for temporarily or more permanently containing computer-readable information. The communications system(s) interface 845 may interface to a wired, wireless, or other type of interfacing connection that permits data to be exchanged with other devices. The communications system(s) 845 may permit data to be exchanged with a network.

The structure 800 may also include additional software elements, shown as being currently located within working memory 830, including an operating system 835 and other code 840, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

As used herein, the term “sender” may refer to any funding source for a money transfer, and a “receiver” may refer to the beneficiary of a money transfer. A sender or receiver may be a person, an organization, a corporation, or any other entity. Also, it is worth noting that the term “transfer” may refer to the combination of a payment by the sender and the money associated with the payment (less a fee) being made available to the receiver.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A host computer system for a receiver-initiated funds transfer, the host computer system configured to:
receive, from a prospective receiver of a funds transfer, an identification of a requested funds transfer amount and a sender identifier to initiate the funds transfer;
receive, from a sender corresponding to the sender identifier, authorization for the funds transfer;
receive a first amount of funds associated with the funds transfer and sourced from the sender; and
transfer, responsive to the receiver initiation, a second amount of funds associated with the funds transfer, the second amount lower than the first amount.

2. The host computer system of claim 1, wherein the received authorization is received before the identification of the requested funds transfer amount and the sender identifier is received from the prospective receiver.

3. The host computer system of claim 2, wherein the received authorization is received when the sender establishes or updates an account with a funds transfer service provider.

4. The host computer system of claim 1, wherein the received authorization comprises a selection by the sender of a receiver who can originate the funds transfer and one or more rules for the funds transfer.

5. The host computer system of claim 1, wherein the received authorization is received after and responsive to the identification of the requested funds transfer amount and the sender identifier is received from the prospective receiver.

6. The host computer system of claim 1, wherein the transfer is made upon receiving the identification of the requested funds transfer amount and the sender identifier, and before the authorization is received.

7. The host computer system of claim 1, wherein the transfer is made after the authorization is received and upon confirmation of receipt of payment.

8. The host computer system of claim 1, wherein the sender establishes an account with a funds transfer service provider before the identification of the requested funds transfer amount and the sender identifier is received.

9. The host computer system of claim 8, wherein,
the account is established through mail, at an agent location, or online through the host computer system;
the authorization received by the host computer system is initiated by the sender via mail, at an agent location, or online through the host computer system; and
the sender identifier comprises a name, an account number, an email address, or another alphanumeric identifier unique to or otherwise identifying the sender.

10. The host computer system of claim 1, wherein the receiver establishes an account with a funds transfer service provider before the identification of the requested funds transfer amount and the sender identifier is received.

11. The host computer system of claim 10, wherein,
the account is established through mail, at an agent location, or online through the host computer system;
the identification of the requested funds transfer amount and the sender identifier are received at different times;
the identification of the requested funds transfer amount is initiated by the receiver via mail, at an agent location, or online through the host computer system; and
the identification the sender identifier is initiated by the receiver via mail, at an agent location, or online through the host computer system.

12. A method for processing a receiver-initiated funds transfer, the method comprising:
receiving, at a host computer system from a prospective receiver of a funds transfer, an identification of a requested funds transfer amount and a sender identifier to initiate the funds transfer;
receiving, at the host computer system from a sender corresponding to the sender identifier, authorization for the funds transfer;
receiving a first amount of funds associated with the funds transfer and sourced from the sender; and
controlling transfer, responsive to the receiver initiation, of a second amount of funds associated with the funds transfer, the second amount lower than the first amount.

13. The method of claim 12, further comprising:
receiving notification of a credit of the first amount of funds, wherein the transfer occurs before the first amount of funds is received.

14. The method of claim 12, wherein receiving the authorization comprises:
receiving the authorization before the identification of the requested funds transfer amount and the identification of the sender identifier are both received from the prospective receiver.

15. The method of claim 12, wherein receiving the authorization comprises:
receiving a selection by the sender of a receiver who can originate the funds transfer and one or more rules limiting the requested funds transfer amount.

16. The method of claim 12, wherein receiving the authorization comprises:
receiving the authorization after the identification of the requested funds transfer amount and the sender identifier is received from the prospective receiver.

17. The method of claim 12, wherein controlling the transfer comprises:
transferring the second amount upon receiving the identification of the requested funds transfer amount and the sender identifier, and before the authorization is received.

18. The method of claim 12, wherein controlling the transfer comprises:
transferring the second amount after the authorization is received and upon confirmation of receipt of payment, wherein the second amount is equal to the requested funds transfer amount.

19. The method of claim 12, wherein the first amount is equal to the requested funds transfer amount, and a difference between the first amount and the second amount comprises a service fee.

20. A system for processing a receiver-initiated funds transfer, the system comprising:
a first set of one or more computing devices associated with the receiver and configured to:
transmit an identification of a requested funds transfer amount; and
transmit a sender identifier;
a second set of one or more computing devices associated with a sender corresponding to the sender identifier, and configured to transmit authorization for the funds transfer; and
a host computer system, in communication with the first set and the second set, and configured to
receive the identification of a requested funds transfer amount and the sender identifier to initiate the funds transfer;
receive the authorization for the funds transfer;
receive notification of a credit of a first amount of funds associated with the funds transfer and sourced from the sender; and
control transfer, responsive to the receiver initiation, of a second amount of funds associated with the funds transfer, the second amount lower than the first amount.
